(19) United States
(12) Patent Application Publication
(10) Pub. No.: US 2006/0174693 A1
(43) Pub. Date: Aug. 10, 2006

(54) Remote humidity monitoring system

(75) Inventors: Chei-Chiang Chen, Taipei City (TW); Po-Yen Wang, Taipei City (TW); Jui-Hung Chien, Sindian City (TW)

Correspondence Address: BACON & THOMAS, PLLC, 625 SLATERS LANE, FOURTH FLOOR, ALEXANDRIA, VA, 22314, US

(73) Assignee: Thinkfar Nanotechnology Corporation, Taipei City (TW)

(21) Appl. No.: 11/252,796

(22) Filed: Oct. 19, 2005

(30) Foreign Application Priority Data
Feb. 4, 2005 (TW) 094103797

(51) Int. Cl. G01N 7/00; G08B 21/00

(52) U.S. Cl. 73/29.01; 340/602

(57) ABSTRACT

A remote humidity monitor system for detecting a targeted object utilizes a humidity sensor to detect humidity and sends a result to a reader via the wireless communication device; a server can execute monitor management. The humidity sensor can be a mass hygrometer, an optical condensation dew-point hygrometer, a psychrometer (wet-and-dry bulb thermometer), a hair hygrometer, an electrolysis humidity sensor, a lithium chloride humidity sensor, an aluminum oxide humidity sensor, a high polymer humidity sensor, or an infrared hygrometer.

### BACKGROUND OF THE INVENTION

1. Field of the Invention

The present invention relates to a remote humidity monitoring system.

2. Description of the Related Art

There are various high-level humidity sensors, such as: mass hygrometers, optical condensation dew-point hygrometers, psychrometers (wet-and-dry bulb thermometers), hair hygrometers, electrolysis humidity sensors, lithium chloride humidity sensors, aluminum oxide humidity sensors, high polymer humidity sensors, or infrared hygrometers. All these humidity sensors can be divided into different types, such as impedance type, capacitance type and other types, according to their theory of operation. The impedance-type humidity sensors utilize organic sensing materials and inorganic sensing materials. Macromolecule organic sensing materials include ammonia, esters, alcohols, etc. Inorganic sensing materials have greater stability than the organic sensing materials, and higher sensitivities in low humidity environments. Low-level humidity sensors also exist, which are used to detect whether the ambient humidity exceeds a threshold value. When the ambient humidity does not exceed the humidity threshold value, the low-level humidity sensor performs no action; when the humidity exceeds the threshold value, the low level humidity sensor generates a warning signal.

Since humidity sensors can be used to detect local humidity conditions, they are usually placed at a target location. However, no humidity sensor exists for the medical/nursing fields.

Therefore, it is desirable to provide an improved remote humidity monitoring system to mitigate and/or obviate the aforementioned problems.

### SUMMARY OF THE INVENTION

A main objective of the present invention is to provide a remote humidity monitor system for observing whether a targeted object is in a state of humidity.

The present invention discloses a remote humidity monitor system for observing whether a targeted object is in a state of humidity, which comprises a humidity sensor for detecting humidity from the targeted object; and a radio frequency pumped device placed on the targeted object and coupled to the humidity sensor, the radio frequency pumped device being capable of sending a radio frequency signal to a far end, wherein when the humidity from the targeted object changes, the humidity sensor is capable of enabling/disabling the radio frequency pumped device; a reader placed at the far end and used for receiving the radio frequency signal and executing a monitoring function according to whether the radio frequency signal is received by the reader.

The present invention discloses a remote humidity monitor system for observing whether a targeted object is in a state of humidity, which comprises a humidity sensor for detecting humidity from the targeted object; a radio frequency pumped device placed on the targeted object and coupled to the humidity sensor, the radio frequency pumped device being capable of sending a radio frequency signal to a far end, wherein, when the humidity from the targeted object changes, the humidity sensor is capable of enabling/disabling the radio frequency pumped device; a reader placed at the far end and used for receiving and outputting the radio frequency signal; and, a server for executing a monitoring function according to whether the radio frequency signal is received by the reader.

The present invention discloses a remote humidity monitor system for observing whether a targeted object is in a state of humidity further, which comprises a humidity sensor for detecting humidity from the targeted object and outputting a detected humidity value; a radio frequency tag placed on the targeted object and coupled to the humidity sensor, the radio frequency tag being capable of sending a radio frequency signal including the detected humidity value to a far end; and a reader placed at the far end and used for receiving the radio frequency signal and executing monitor function according to the detected humidity value of the radio frequency signal.

The present invention discloses a remote humidity monitor system for observing whether a targeted object is in a state of humidity further comprises a humidity sensor for detecting humidity from the targeted object and outputting a detected humidity value; a radio frequency tag placed on the targeted object and coupled to the humidity sensor, the radio frequency tag being capable of sending a radio frequency signal including the detected humidity value to a far end; a reader placed at the far end and used for receiving and outputting the radio frequency signal; and, a server for executing a monitor function according to the detected humidity value of the radio frequency signal of the reader.

In the above-mentioned description, the humidity sensor can be a comb electrode, a mass hygrometer, an optical condensation dew-point hygrometer, a psychrometer (wet-and-dry bulb thermometer), a hair hygrometer, an electrolysis humidity sensor, a lithium chloride humidity sensor, an aluminum oxide humidity sensor, a high polymer humidity sensor, or an infrared hygrometer.

Other objects, advantages, and novel features of the invention will become more apparent from the following detailed description when taken in conjunction with the accompanying drawings.

### BRIEF DESCRIPTION OF THE DRAWINGS

FIG. 1 is a schematic drawing of a remote humidity monitoring system in a first embodiment of the present invention.

FIG. 2 is a schematic drawing of a remote humidity monitoring system in a second embodiment of the present invention.

### DETAILED DESCRIPTION OF THE PREFERRED EMBODIMENT

A remote humidity monitoring system of the present invention utilizes a wireless communications transmitting module to send a detected humidity value to a reader. The following description provides two embodiments of the present invention.

### First Embodiment

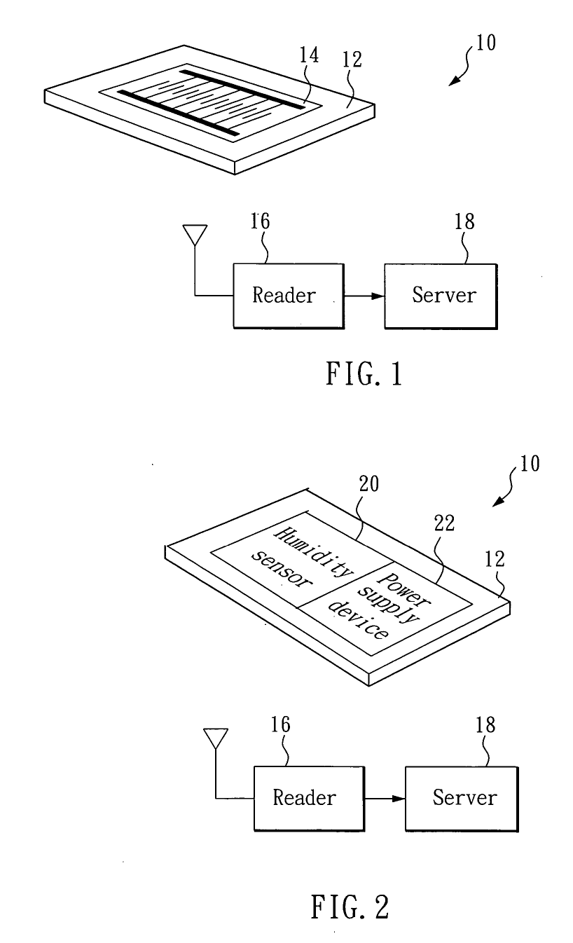

As shown in FIG. 1, a remote humidity monitoring system 10 comprises a radio frequency tag 12, a comb electrode 14, and a reader 16.

The radio frequency tag 12 is a primary element provided in RFID (radio frequency identification) systems, and can communicate with another primary element. The radio frequency tag 12 can be divided into an active radio frequency tag and a passive radio frequency tag, which are both formed from a substrate, a coil antenna and a control chip. The coil antenna and the control chip both are mounted on the substrate. The active radio frequency tag further comprises a power supply device. In this embodiment, the radio frequency tag 12 is a passive radio frequency tag to allow for reduced sizes. The coil antenna is used for receiving electromagnetic pulses, which excite the coil antenna to generate power for the control chip; the control chip then causes the coil antenna to transmit a radio frequency signal to a far end. To enhance the humidity monitor abilities of the system, a working frequency of the radio frequency tag 12 (the frequency of the radio signal) is preferably a far-field frequency band, such as a high frequency band (13.56 MHz), an ultrahigh frequency band (860˜930 MHz), or a microwave frequency band (2.45 GHz). The radio frequency tag 12 can be placed on clothes, on a diaper worn by a person being monitored, attached to the monitored person, or glued, locked, fastened, etc. onto a monitored object.

A comb electrode 14 is connected to the coil antenna of the radio frequency tag 12, which has two electrodes. When a conductive object is placed between the two electrodes, a short circuit is formed between the two electrodes.

The reader 16 is used to send the electromagnetic impulse and receive the radio frequency signal for, preferably, a server 18. The server 18 can support more than one remote humidity monitoring system 10. An antenna of the reader 16 continuously sends the electromagnetic impulses to the radio frequency tag 12 at a far end, receiving the radio frequency response sent from the coil antenna, and then outputs the radio frequency signal to the server 18. The server 18 is capable of receiving a radio frequency signal that indicates that the monitored person is away from water, or has a dry diaper. When the monitored person is close to water or has a wet diaper, the comb electrode 14 experiences a short circuit due to the humidity, and since the comb electrode 14 is connected to the coil antenna, the coil antenna cannot function normally. Therefore, the reader 16 does not receive the radio frequency signal from the radio frequency tag 12, and the server 18 can send a warning signal according to the radio frequency signal that has disappeared. The comb electrode 14 can be in series with the coil antenna of the radio frequency tag 12, which only affects the radio frequency tag 12, but which is substantially similar to the previous embodiment, and so requires no further description. The server 18 can execute a subsequent process according to whether the reader 16 can receives the signal; alternatively, if the reader 16 can provide automatic control management functions, then the server 18 can be omitted.

### Second Embodiment

As shown in FIG. 2, a remote humidity monitoring system 10 comprises a radio frequency tag 12, a humidity sensor 20, a power supply device 22, and a reader 16.

The humidity sensor 20 can be a mass hygrometer, an optical condensation dew-point hygrometer, a psychrometer (wet-and-dry bulb thermometer), a hair hygrometer, an electrolysis humidity sensor, a lithium chloride humidity sensor, an aluminum oxide humidity sensor, a high polymer humidity sensor, or an infrared hygrometer. The humidity sensor 20 is used to detect the current humidity and outputs a humidity value to the control chip of the radio frequency tag 12.

The radio frequency tag 12, in this embodiment, is preferably a radio frequency tag. The control chip can input a humidity value and perform a modulation process to generate a radio frequency signal. The control chip then outputs the radio frequency signal, which encodes the humidity value, to the coil antenna. Further reference may be made to the first embodiment, since the active radio frequency tag and the passive radio frequency tag are similar in operation.

The power supply device 22 is used to provide power to the humidity sensor 20 and the radio frequency tag 12.

The operating principles for the reader 16 and the server 18 may be referred to in the first embodiment.

In the present invention, the radio frequency tag 12 can be placed on the clothes or a diaper worn by the person being monitored, and the comb electrode 14 or the humidity sensor 20 is coupled to the radio frequency tag 12. Consequently, the humidity value can be sent to the reader 16 to monitor whether or not the monitored person is too close to water or has a wet diaper.

Although the present invention has been explained in relation to its preferred embodiment, it is to be understood that many other possible modifications and variations can be made without departing from the spirit and scope of the invention as hereinafter claimed.

What is claimed is:

1. A remote humidity monitoring system for observing whether a targeted object is in a state of humidity, the remote humidity monitoring system comprising:
a humidity sensor for detecting humidity from the targeted object;
a radio frequency pumped device placed on the targeted object and coupled to the humidity sensor, the radio frequency pumped device being capable of sending a radio frequency signal to a far end, wherein, when the humidity from the targeted object changes, the humidity sensor is capable of enabling/disabling the radio frequency pumped device; and
a reader placed at the far end and used for receiving the radio frequency signal and executing a monitoring function according to whether the radio frequency signal is received by the reader.

2. The remote humidity monitoring system as claimed in claim 1, wherein the radio frequency pumped device is a radio frequency tag, the radio frequency tag comprises a substrate, a coil antenna and a control chip.

3. The remote humidity monitoring system as claimed in claim 2, wherein the coil antenna and the humidity sensor are in parallel or series connection.

4. The remote humidity monitoring system as claimed in claim 1, wherein the humidity sensor is a comb electrode.

5. The remote humidity monitoring system as claimed in claim 1, wherein the remote humidity monitor system further comprises a power supply device.

6. A remote humidity monitoring system for observing whether a targeted object is in a state of humidity, the remote humidity monitoring system comprising:
a humidity sensor for detecting humidity from the targeted object;
a radio frequency pumped device placed on the targeted object and coupled to the humidity sensor, the radio frequency pumped device being capable of sending a radio frequency signal to a far end, wherein, when the humidity from the targeted object changes, the humidity sensor is capable of enabling/disabling the radio frequency pumped device;
a reader placed at the far end and used for receiving and outputting the radio frequency signal; and
a server for executing a monitoring function according to whether the radio frequency signal is received by the reader.

7. The remote humidity monitoring system as claimed in claim 6, wherein the radio frequency tag comprises a substrate, a coil antenna and a control chip.

8. The remote humidity monitoring system as claimed in claim 7, wherein the coil antenna and the humidity sensor are in parallel or series connection.

9. The remote humidity monitoring system as claimed in claim 6, wherein the humidity sensor is a comb electrode.

10. The remote humidity monitoring system as claimed in claim 6, wherein the remote humidity monitoring system further comprises a power supply device.

11. A remote humidity monitoring system for observing whether a targeted object is in a state of humidity, the remote humidity monitoring system comprising:
a humidity sensor for detecting humidity from the targeted object and outputting a detected humidity value;
a radio frequency tag placed on the targeted object and coupled to the humidity sensor, the radio frequency tag being capable of sending a radio frequency signal including the detected humidity value to a far end; and
a reader placed at the far end and used for receiving the radio frequency signal and executing monitor function according to the detected humidity value of the radio frequency signal.

12. The remote humidity monitoring system as claimed in claim 11, wherein the radio frequency tag comprises a substrate, a coil antenna and a control chip.

13. The remote humidity monitoring system as claimed in claim 12, wherein the coil antenna and the humidity sensor are in parallel or series connection.

14. The remote humidity monitoring system as claimed in claim 11, wherein the humidity sensor is a mass hygrometer, an optical condensation dew-point hygrometer, a psychrometer (wet-and-dry bulb thermometer), a hair hygrometer, an electrolysis humidity sensor, a lithium chloride humidity sensor, an aluminum oxide humidity sensor, a high polymer humidity sensor, or an infrared hygrometer.

15. The remote humidity monitoring system as claimed in claim 11, wherein the remote humidity monitoring system further comprises a power supply device.

16. A remote humidity monitoring system for observing whether a targeted object is in a state of humidity, the remote humidity monitoring system comprising:
a humidity sensor for detecting humidity from the targeted object and outputting a detected humidity value;
a radio frequency tag placed on the targeted object and coupled to the humidity sensor, the radio frequency tag being capable of sending a radio frequency signal including the detected humidity value to a far end;
a reader placed at the far end and used for receiving and outputting the radio frequency signal; and
a server for executing a monitor function according to the detected humidity value of the radio frequency signal of the reader.

17. The remote humidity monitoring system as claimed in claim 16, wherein the radio frequency tag comprises a substrate, a coil antenna and a control chip.

18. The remote humidity monitoring system as claimed in claim 17, wherein the coil antenna and the humidity sensor are in parallel or series connection.

19. The remote humidity monitoring system as claimed in claim 16, wherein the humidity sensor is a mass hygrometer, an optical condensation dew-point hygrometer, a psychrometer (wet-and-dry bulb thermometer), a hair hygrometer, an electrolysis humidity sensor, a lithium chloride humidity sensor, an aluminum oxide humidity sensor, a high polymer humidity sensor, or an infrared hygrometer.

20. The remote humidity monitoring system as claimed in claim 16, wherein the remote humidity monitoring system further comprises a power supply device.
